(19) United States
(12) Patent Application Publication
(10) Pub. No.: US 2003/0180037 A1
(43) Pub. Date: Sep. 25, 2003

(54) LED flash device for camera

(76) Inventor: Mathew Sommers, Sagamore Hills, OH (US)

Correspondence Address: FAY, SHARPE, FAGAN, MINNICH & MCKEE, LLP, 1100 SUPERIOR AVENUE, SEVENTH FLOOR, CLEVELAND, OH, 44114, US

(21) Appl. No.: 10/063,103

(22) Filed: Mar. 21, 2002

(51) Int. Cl. G03B 15/03

(52) U.S. Cl. 396/155

(57) ABSTRACT

An electronic flash apparatus for a camera includes a housing, a white light LED (light emitting diode) mounted in the housing, and a cover lens mounted on an open end of the housing. A DC power supply and control circuit provide power to the LED via lead wires. The activation of the LED may be synchronized with the taking of a picture by an associated camera. The LED allows for an improved flash by reducing the manufacturing cost and the number of parts needed for a conventional flash using a discharge tube.

### BACKGROUND OF INVENTION

The invention relates generally to the field of photography, and in particular to an electronic flash apparatus for a camera. More particularly, the present invention is directed to an improved camera flash device that replaces the conventional flash discharge tube with one or more LEDs.

The use of an electronic flash in various kinds of optical apparatus is well known. Particularly, in the art of photography, artificial light is used to illuminate an object to be photographed. One form of artificial light which has been in wide use is so-called electric flash device. In such devices, a flash tube is provided in order to illuminate the object to be photographed. Flash firing is produced by an instantaneous electronic discharge between two electrodes in the gas-filled flash tube. The light from the flash tube can be used to illuminate the object to take a picture. Accordingly, the flash device is mainly used to take a picture of an object in dim light as well as to remove the unwanted shadow of an object to be photographed in daylight conditions.

Typically, the main components of an electronic flash unit are a flash circuit board, a flash reflector, a flash tube positioned within the flash reflector, and a transparent or translucent flash cover-lens. The flash reflector, the flash tube and the flash cover-lens are mounted on the flash circuit board. The flash reflector is shaped to concentrate the flash light produced by the flash tube and to direct the flash light through a front open end of the reflector towards the subject to be illuminated. One efficient shape for the reflector is a parabola which concentrates the flash light into a beam that may have parallel, converging or diverging rays according to whether the flash tube is at the focal point of the parabola, in front of the focal point, or behind the focal point. The flash cover-lens covers the front open end of the flash reflector and can act as a light diffuser, softening the flash light and spreading it more evenly over the subject to be illuminated.

A conventional flash tube is filled with an ionizable gas, and it has an in-line pair of anode and cathode main electrodes at its opposite ends which protrude from respective side openings in the flash reflector and are connected to a capacitor on the flash circuit board. The capacitor is connected to a power source, such as a battery, and acts as a charging member for the flash tube. The resistance of the gas in the flash tube is normally too high to permit a direct discharge. Thus, a third electrode, i.e. a triggering electrode, is provided for firing the flash tube. The flash reflector often is located in a hole or cut-out in the flash circuit board and the rear closed end of the flash reflector protrudes from the hole or cut-out. The flash tube is urged against an inner side of the rear closed end of the flash reflector, such as by an elastomeric band. When the triggering electrode applies a triggering voltage to the flash reflector, the gas in the flash tube is ionized, thus lowering its resistance and allowing the capacitor to discharge its stored energy through the flash tube in the form of a flash of light. See, e.g., U.S. Pat. No. 4,223,372 issued Sep. 16, 1980, U.S. Pat. No. 5,047,900 issued Sep. 10, 1991, and U.S. Pat. No. 5,436, 685 issued Jul. 25, 1995.

Light Emitting Diodes (LEDs) are solid state semi-conductor devices that convert electrical energy into light. LEDs are made from a combination of semi-conductors and generate light when current flows across the junctions of these materials. The color of the light produced by the LED is determined by the combination of materials used in its manufacture. LEDs have made significant advances in providing a higher performing light source since their inception. For example, red-emitting AlGaAs (aluminum gallium arsenide) LEDs have been developed with efficacies greater than 20 lumens per electrical watt, such devices being more energy efficient and longer lasting producers of red light than red-filtered incandescent bulbs. More recently, AlGalnP (aluminum gallium indium phosphide) and lnGaN (indium gallium nitride) LED's have succeeded ALGaAs as the brightest available LEDs.

It can be quite costly and labor intensive to manufacture a flash device. For example, in one type of conventional electric flash device, a lead is wound and fastened on the surface of the flash tube in the vicinity of positive electrode and, furthermore, a translucent conductive film is coated on the whole surface of the tube to form the trigger electrode. Additionally, a coat of silver paint is often applied after winding the lead on the conductive film in order to make good electrical contact between the conductive film and the lead. In addition, electric flash units often use complex reflector and lens optics to create a uniform light beam. This is necessary due to the non-directionality of the light emitted from the flash tube. Further, modern electric flashes tend to involve a complicated manufacturing process and the use of expensive parts. The costs are commensurately unfavourable. Moreover, the flash units now used in cameras are delicate and prone to breakage if the camera is subjected to physical abuse.

Thus, it would be advantageous to develop a flash system for a camera that is relatively inexpensive to produce, more durable than conventional flash systems, and that could be made simpler without the use of complex reflector optics to create a uniform beam pattern.

### SUMMARY OF INVENTION

In a first aspect, an electronic camera flash unit is provided comprising a housing, a white LED mounted in the housing and a cover lens positioned over an open end of the housing for transmitting light emitted from the LED.

In a second aspect, a camera is provided comprising a camera body, a housing having an open end, an LED mounted in the housing such that light emitted from the LED is directed through the open end of the housing toward an object to be photographed, a cover lens mounted on the open end of the housing for transmitting light emitted from the LED, a DC power supply, a control circuit, and a wire for connecting the DC power supply and the control circuit to the LED.

In a third aspect, a method for producing an LED electronic flash apparatus for a camera is provided including the steps of providing a white light LED, providing a housing, providing a cover lens having an open end, providing a DC power source, mounting the LED in the housing, mounting the cover lens over the open end of the housing, operatively connecting the DC power source to the LED, and mounting the housing, the LED and the DC power source in a camera.

One advantage of the present invention is the provision of an electronic camera flash that is more durable than traditional flash units and is less prone to breakage when subjected to physical stress.

Another advantage of the present invention resides in the reduced cost of manufacturing an electronic flash due to the decreased number of components.

Still other benefits and advantages of the invention will become apparent to those skilled in the art upon a reading and understanding of the following detailed specification.

### BRIEF DESCRIPTION OF DRAWINGS

The present invention will be described in detail with several preferred embodiments and illustrated, merely by way of example and not with intent to limit the scope thereof, in the accompanying drawings.

FIG. 1 is a front view of a camera equipped with the LED electronic flash apparatus in accordance with the present invention.

FIG. 2 is a is a partially exploded side cross-sectional view of an LED flash apparatus in accordance with an embodiment of the present invention.

FIG. 3 is a side cross-sectional view of an LED flash apparatus in accordance with an embodiment of the present invention.

FIG. 4 is a front perspective view of an LED electronic flash apparatus in accordance with an embodiment of the present invention.

### DETAILED DESCRIPTION

The present invention provides an LED electronic flash apparatus. While it is contemplated that the LED flash will be used in a camera and the invention will thus be described in that context, the present invention may, of course, be used in other applications calling for the use of an electronic flash as well.

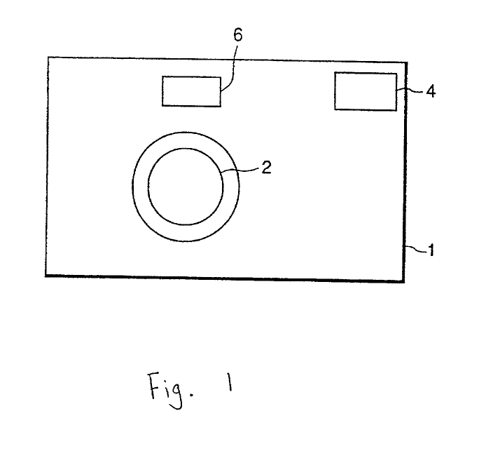

With reference to FIG. 1, a camera in accordance with the present invention includes a camera body 1, on which there is provided a photographic lens 2, an LED electronic flash apparatus 4, and a view finder window 6.

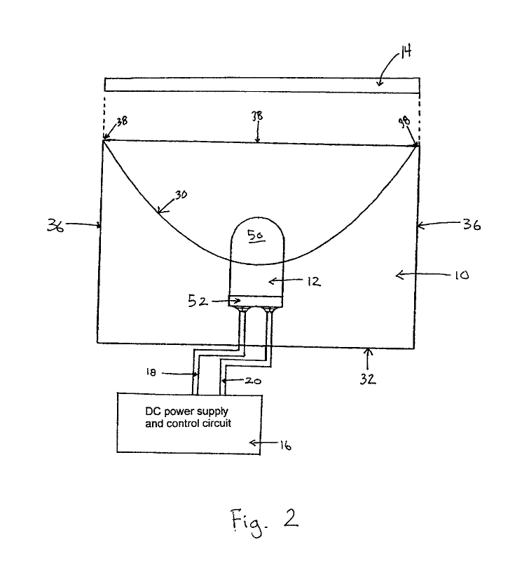

FIG. 2 shows a cross-sectional view of an LED electronic flash apparatus in accordance with one embodiment of the present invention. The apparatus includes a housing 10 mounted in the camera body 1, an LED 12 mounted in said housing, a cover lens 14 positioned over an open end of the housing. Also included is a DC power supply and control circuit 16 that selectively supplies power to the LED 12 through an electrical transmitter, for example a first 18 and second 20 lead wire.

The housing 10 of the present invention includes an interior surface 30, a bottom surface 32 and side surfaces 36 that extend up to form a top perimeter surface 38 defining an open end of said housing. Of course it must be recognized that the terms “top” and “bottom” are used herein in a relative sense and that when mounted in a camera, the top perimeter surface 38 will be facing toward the front of the camera and the bottom surface 32 the back of the camera. The housing 10 is preferably made from a tough, light-weight, and inexpensive thermoplastic, although other materials may be used. When mounted, the top perimeter surface 38 is preferably flush mounted with the front surface of the camera body 1.

In a conventional electronic flash, the interior surface 30 of the housing is typically made of, or coated with, a reflective material and is parabolic in shape to conserve light emitted by the flash tube and to direct the light at the object to be illuminated. This is because the flash tubes typically used are non-directional, emitting light in all directions. This arrangement avoids wasting light emitted to the back and sides of the housing by the omnidirectional flash tube.

The present invention, on the other hand, does not require a reflective and parabolic housing interior surface 30. This is because light emitted by LEDs is very directional. It is known in the art to manufacture LEDs that have various emission angles. See, for example, U.S. Pat. No. 5,931,570 to Yamuro, the disclosure of which is incorporated herein by reference in its entirety. In the present invention, an LED is preferably used that has an emission angle such all the emitted light is directed to the open end of the housing and minimal or no light is directed to the interior surface 30 of the housing. This ensures that all light emitted by the LED 12 is efficiently directed toward an object to be photographed. Of course, a housing 10 having a reflector comprising a parabolic shaped reflective interior surface 30 may still be used if desired, especially if an LED having a wider emission angle is utilized.

As shown in FIG. 1, the housing 10 is preferably mounted in the camera body 1, to conserve space and allow for the smallest possible camera dimension. Alternately, the housing may be mounted exterior to the camera body and attached by means of a hinge, snap-together fitting, or some other attachment apparatus (not shown). This allows the flash apparatus to be removed from the camera if desired.

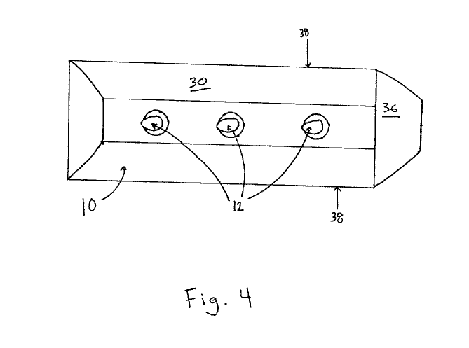

Either a single LED or an array of LEDs may be used in the present invention. For example, with reference to FIG. 4, an LED flash apparatus is shown containing three LEDs 12. The use of multiple LEDs in the flash apparatus allows for a corresponding greater amount of light to be emitted. The LEDs 12 should be configured to all flash at the same moment to effectively combine the light emitted by each of the LEDs.

In a preferred embodiment, High Brightness (HB) and Ultra High Brightness (UHB) LEDs are used in the invention, which are capable of emitting light of intensities that meet or exceed that of traditional bulbs. These HB-LEDs are grown using sophisticated compound semiconductor epitaxial growth techniques, the most common of which is metalorganic chemical vapor deposition (MOCVD).

Preferably, a white light LED is used in the invention. Suitable for use in the present invention are UV and blue LEDs that generate white light via the application of luminescent phosphor materials on top of the LED. In one technique, a layer of phosphor partially transforms the UV or blue light into longer wavelengths, e.g. yellow light. These LEDs efficiently extract white light by efficiently converting the UV/blue light into visible light of the desired wavelength. A detailed disclosure of a UV/Blue LED-Phosphor Device with efficient conversion of UV/Blue Light to visible light suitable for use in the present invention may be found in U.S. Pat. No. 5,813,752 (Singer) and U.S. Pat. No. 5,813,753 (Vriens), the disclosures of which are incorporated herein by reference in their entirety. Other types of white LEDs are also contemplated. These white light LEDs are capable of emitting enough light to satisfy the needs of electronic flash camera users. Thus, in a particularly preferred embodiment, the LEDs are high intensity white light LEDs.

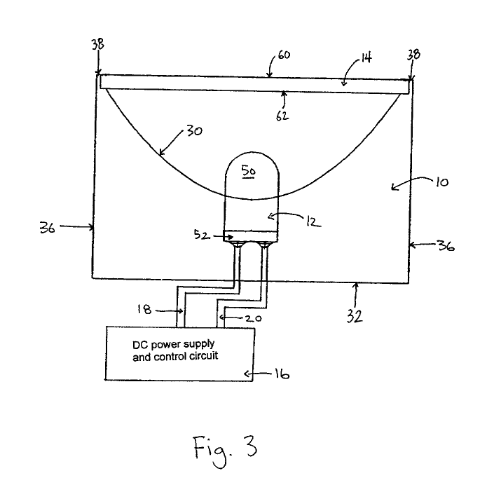

With further reference to FIGS. 2 and 3, in one embodiment of the present invention, the LED includes a transparent protective bulb shaped portion 50 made from epoxy resin or other material, an LED chip 52 embedded in the bulb shaped portion and first and second lead wires 18, 20 connecting the LED chip to the control circuit and DC power supply 16.

To further increase the light emitted by the flash apparatus of the present invention, the LED 12 can be made with high internal resistance such that they can safely be overrun in excess of manufacturer's stated maximum voltage or current levels without detriment. This allows an LED to emit greater amounts of light that is ordinarily possible. Such techniques are known in the art. See, for example, U.S. Pat. No. 6,331,062 to Sinclair, the disclosure of which is incorporated herein by reference in its entirety.

Although illustrated as one structure for convenience in the accompanying Figures, it should be understood that the DC power supply and control circuit 16 are typically made up of distinct, albeit interconnected elements, including at least one DC power supply and at least one control circuit. Such elements suitable for use in flash photography are known in the art. In one embodiment, the DC power supply and control circuit 16 includes one or more battery cells (not shown) which can be any suitable technology, including but not limited to alkaline, nickel cadmium, standard, heavy duty, lithium, nickel metal hydride and others. Alternately, other suitable DC electrical power supplies can be used as desired in place of a battery. Various types of control circuits suitable for use in conventional electronic flashes are also suitable for use in the present invention, and are known in the art. The DC power supply and control circuit 16 includes a switch or other signal generating mechanism (not shown) that allows the user to selectively supply power from the DC power supply to the LED. In a preferred embodiment, this switch is sychronized with activation of a shutter (not shown) on the associated camera, thereby supplying power to and activating the LED 12 when a picture is being taken. Also preferably part of the control circuit is a control mechanism that determines whether to supply power to the LED when a picture is being taken based on the amount of ambient light present and the desires of the camera user.

As shown in FIGS. 2 and 3, the flash apparatus may include a cover lens 14 positioned over the housing 10 for focusing and dispersing the light emitted as well as for protecting the LED 12. The cover lens 14 preferablycomprises a rigid plastic, although other materials such as glass are also contemplated. Such a cover lens 14 may be opaque or transparent, depending on the type of emitted light desired. Front 60 and back 62 surfaces of the cover lens can be smooth such that the light emitted from the LED 12 passes through it without substantial refraction. Alternately, one or both of the front 60 and back 62 surfaces of the cover lens 14 can be a fresnel lens or otherwise shaped to collimate or direct the light emitted by the LED. Examples of such lens shapes can be found in U.S. Pat. No. 5,617,163 to Ohtake and U.S. Pat. No. 6,016,406 to Lungershausen, the disclosures of which are incorporated herein by reference in their entirety. Of course, the lens may also be a diffractive or conventional refractive lens or, in fact, since LEDs are typically much more sturdy than traditional flash tubes, no lens may be used at all.

With further reference to FIG. 2, the cover lens 14 can be mounted on top perimeter surface 38 of the housing 10. As noted above, however, the top perimeter surface 38 of the housing is preferably flush mounted with the remainder of front surface of the camera body 1. As such, the cover lens 14 would then extend beyond the housing 10 and present a raised profile on the front surface of the camera body 1. Therefore, the cover lens 14 is preferably mounted such that it is flush with the top perimeter surface 38 of the housing 10 and the front of the camera body 1, as shown in FIG. 3. The cover lens 14 is mounted in any conventional manner to the housing and/or camera body, such as an adhesive, fixing posts or other attachment mechanisms.

The invention has been described with reference to the preferred embodiment. Obviously, modifications and alterations will occur to others upon a reading and understanding of this specification. The invention is intended to include all such modifications and alterations in so far as they come within the scope of the appended claims and the equivalents thereof.

1. An electronic flash apparatus for a camera comprising:
a housing having an open end;
a white light LED mounted in said housing; and
a cover lens positioned over said open end of said housing for transmitting light emitted from said LED.

2. The electronic flash apparatus of claim 1, further comprising a DC power supply.

3. The electronic flash apparatus of claim 2, wherein said DC power supply includes a battery cell of a type selected from the group consisting of alkaline, nickel cadmium, standard, heavy duty, lithium, and nickel metal hydride batteries.

4. The electronic flash apparatus of claim 1, further comprising a power and control circuit.

5. The electronic flash apparatus of claim 4, wherein said power and control circuit includes a switch that allows power from a DC power supply to be selectively provided to said LED.

6. The electronic flash of claim 4, wherein said power and control circuit allows said LED to by synchronized with an associated camera such that said LED is activated when a picture is taken with said camera.

7. The electronic flash apparatus of claim 1, wherein said cover lens is a fresnel lens.

8. The electronic flash apparatus of claim 1, wherein said cover lens is a refractive lens.

9. The electronic flash apparatus of claim 1, wherein said LED is a white light UV-phosphor LED.

10. The electronic flash apparatus of claim 8, wherein said LED is a high brightness or ultra high brightness LED.

11. The electronic flash apparatus of claim 1, wherein said cover lens is mounted such that it is flush mounted with a front surface of a body of an associated camera.

12. The electronic flash apparatus of claim 1, wherein said LED includes a transparent protective portion and an LED chip embedded in said protective portion.

13. The electronic flash apparatus of claim 1 comprising a plurality of LEDs.

14. The electronic flash apparatus of claim 1, wherein said LED has a light emission angle such that the LED does not emit light directed at said housing.

15. The electronic flash apparatus of claim 1, comprising a single LED.

16. The electronic flash apparatus of claim 1, wherein said flahs apparatus is free of a reflector.

17. The electronic flash apparatus of claim 1, further comprising a reflector mounted in said housing for directing light emitted by said LED toward said open end of said housing.

18. An electronic flash apparatus for a camera comprising:
a housing having an open end;
a white light LED mounted in said housing; and
a reflector mounted in said housing.

19. The electronic flash apparatus of claim 18, wherein said reflector comprises a reflective interior surface of said housing.

20. A camera comprising:
a camera body;
a housing having an open end;
an LED mounted in said housing such that light emitted from said LED is directed through said open end of said housing toward an object to be photographed;
a cover lens mounted on said open end of said housing for transmitting light
emitted from said LED;
a DC power supply;
a control circuit; and,
a means for connecting said DC power supply and said control circuit to said LED.

21. A method for producing an LED electronic flash apparatus for a camera
comprising the steps of:
providing a white light LED;
providing a housing having an open end;
providing a cover lens;
providing a DC power source;
mounting said LED in said housing;
mounting said cover lens over said open end of said housing;
operatively connecting said DC power source to said LED; and,
mounting said housing, said LED and said DC power source in a camera.

22. The method according to claim 18, wherein the step of providing a white light LED is performed by providing a UV-phosphor white light LED.
